(19) United States
(12) Patent Application Publication
(10) Pub. No.: US 2009/0018826 A1
(43) Pub. Date: Jan. 15, 2009

(54) Methods, Systems and Devices for Speech Transduction

(76) Inventor: Andrew A. Berlin, San Jose, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 12/173,021

(22) Filed: Jul. 14, 2008

Related U.S. Application Data
(60) Provisional application No. 60/959,443, filed on Jul. 13, 2007.

(51) Int. Cl. G10L 19/12

(52) U.S. Cl. 704/223; 704/E19.001

(57) ABSTRACT

Methods, systems, and devices for speech transduction are disclosed. One aspect of the invention involves a computer-implemented method in which a computer receives far-field acoustic data acquired by one or more microphones. The far-field acoustic data are analyzed. The far-field acoustic data are modified to reduce characteristics of the far-field acoustic data that are incompatible with human speech characteristics of near-field acoustic data.

### RELATED APPLICATIONS

This application claims priority to U.S. Provisional Application No. 60/959,443, filed on Jul. 13, 2007, which application is incorporated by reference herein in its entirety.

### TECHNICAL FIELD

The disclosed embodiments relate generally to methods, systems, and devices for audio communications. More particularly, the disclosed embodiments relate to methods, systems, and devices for speech transduction.

### BACKGROUND

Traditionally, audio devices such as telephones have operated by seeking to faithfully reproduce the sound that is acquired by one or more microphones. However, phone call quality is often very poor, especially in hands-free applications, and significant improvements are needed. For example, consider the operation of a speakerphone, such as those that are commonly built into cellular telephone handsets. A handset's microphone is operating in a far field mode, with the speaker typically located several feet from the handset. In far field mode, certain frequencies do not propagate well over distance, while other frequencies, which correspond to resonant geometries present in the room, are accentuated. The result is the so-called tunnel effect. To a listener, the speaker's voice is muffled, and the speaker seems to be talking from within a deep tunnel. This tunnel effect is further confounded by ambient noise present in the speaker's environment.

The differences between near and far field are further accentuated in the case of cellular telephones and voice over IP networks. In cellular telephones and voice over IP networks, codebook-based signal compression codecs are heavily employed to compress voice signals to reduce the communication bandwidth required to transmit a conversation. In these compression schemes, the selection of which codebook entry to use to model the speech is typically heavily influenced by the relative magnitudes of different frequency components in the voice. Acquisition of data in the far field has a tendency to alter the relative magnitudes of these components, leading to a poor codebook entry selection by the codec and further distortion of the compressed voice.

Similar problems occur with the voice quality of speech acquired by far field microphones in other devices besides communications devices (e.g., hearing aids, voice amplification systems, audio recording systems, voice recognition systems, and voice-enabled toys or robots).

Accordingly, there is a need for improved methods, systems, and devices for speech transduction that reduce or eliminate the problems associated with speech acquired by far-field microphones, such as the tunnel effect.

### SUMMARY

The present invention overcomes the limitations and disadvantages described above by providing new methods, systems, and devices for speech transduction.

In accordance with some embodiments, a computer-implemented method of speech transduction is performed. The computer-implemented method includes receiving far-field acoustic data acquired by one or more microphones. The far-field acoustic data is analyzed. The far-field acoustic data is modified to reduce characteristics of the far-field acoustic data that are incompatible with human speech characteristics of near-field acoustic data.

In accordance with some embodiments, a computer system for speech transduction includes: one or more processors; memory; and one or more programs. The one or more programs are stored in the memory and configured to be executed by the one or more processors. The one or more programs include instructions for: receiving far-field acoustic data acquired by one or more microphones; analyzing the far-field acoustic data; and modifying the far-field acoustic data to reduce characteristics of the far-field acoustic data that are incompatible with human speech characteristics of near-field acoustic data.

In accordance with some embodiments, a computer readable storage medium has stored therein instructions, which when executed by a computing device, cause the device to: receive far-field acoustic data acquired by one or more microphones; analyze the far-field acoustic data; and modify the far-field acoustic data to reduce characteristics of the far-field acoustic data that are incompatible with human speech characteristics of near-field acoustic data.

Thus, the invention provides methods, systems, and devices with improved speech transduction that reduces the characteristics of far-field acoustic data that are incompatible with human speech characteristics of near-field acoustic data.

### BRIEF DESCRIPTION OF THE DRAWINGS

For a better understanding of the aforementioned aspects of the invention as well as additional aspects and embodiments thereof, reference should be made to the Description of Embodiments below, in conjunction with the following drawings in which like reference numerals refer to corresponding parts throughout the figures.

FIG. 1 is a block diagram illustrating an exemplary distributed computer system in accordance with some embodiments.

FIG. 2 is a block diagram illustrating a speech transduction server in accordance with some embodiments.

FIGS. 3A and 3B are block diagrams illustrating two exemplary speech transduction devices in accordance with some embodiments.

FIGS. 4A, 4B, and 4C are flowcharts of a speech transduction method in accordance with some embodiments.

FIG. 5 is a flowchart of a speech transduction method in accordance with some embodiments.

FIG. 6A depicts a waveform of human speech.

FIG. 6B depicts a spectrum of near-field speech.

FIG. 6C depicts a spectrum of far-field speech.

FIG. 6D depicts the difference between the spectrum of near-field speech (FIG. 6B) and the spectrum of far-field speech (FIG. 6C).

FIG. 7A is a block diagram illustrating a speech transduction system in accordance with some embodiments.

FIG. 7B illustrates three scenarios for speaker identification and voice model retrieval in accordance with some embodiments.

FIG. 7C illustrates three scenarios for voice replication in accordance with some embodiments of the present invention.

### DESCRIPTION OF EMBODIMENTS

Methods, systems, devices, and computer readable storage media for speech transduction are described. Reference will be made to certain embodiments of the invention, examples of which are illustrated in the accompanying drawings. While the invention will be described in conjunction with the embodiments, it will be understood that it is not intended to limit the invention to these particular embodiments alone. On the contrary, the invention is intended to cover alternatives, modifications and equivalents that are within the spirit and scope of the invention as defined by the appended claims.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well-known to those of ordinary skill in the art are not described in detail to avoid obscuring aspects of the present invention.

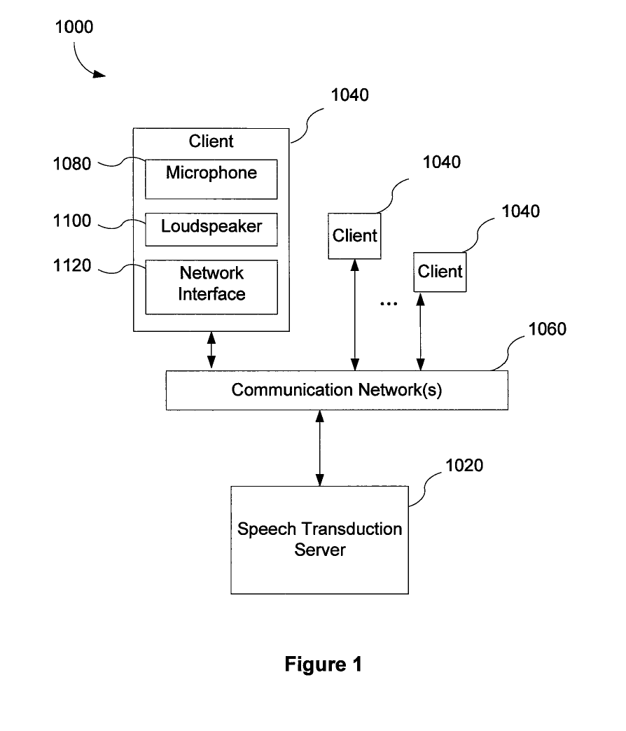

FIG. 1 is a block diagram illustrating an exemplary distributed computer system 100 according to some embodiments. FIG. 1 shows various functional components that will be referred to in the detailed discussion that follows. This system includes speech transduction devices 1040, speech transduction server 1020, and communication network(s) 1060 for interconnecting these components.

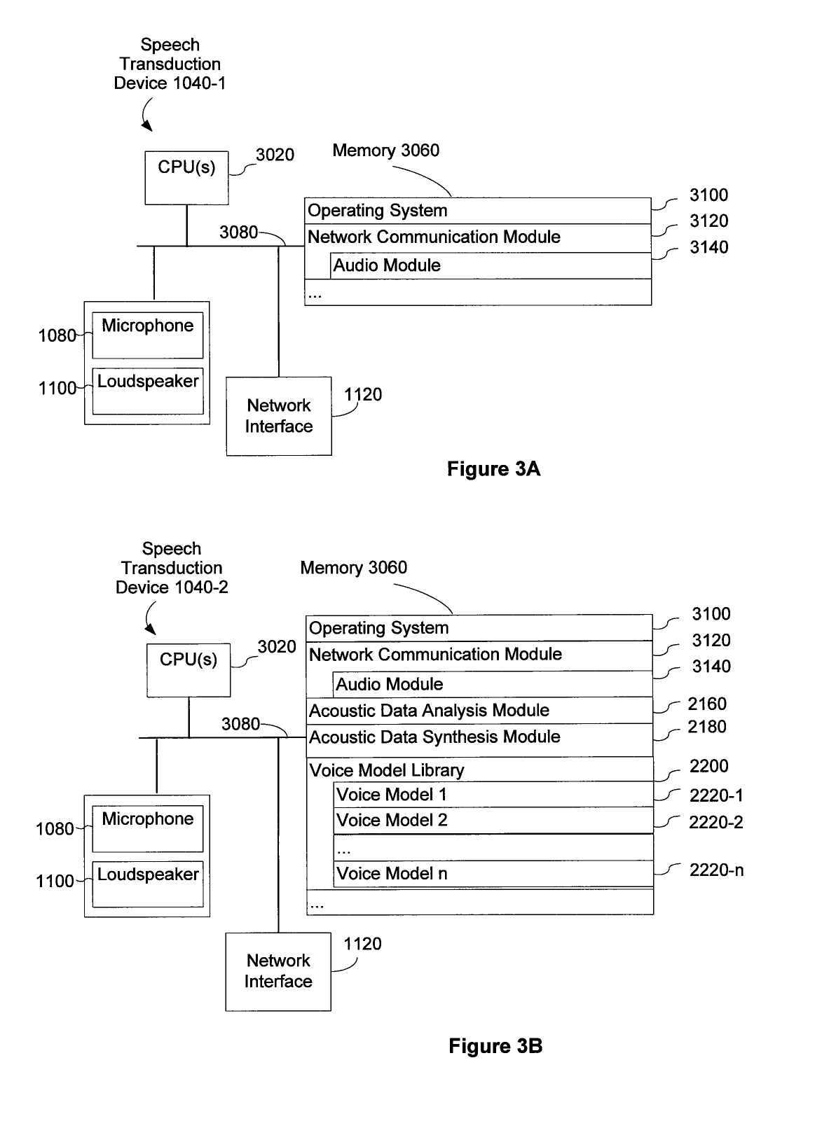

Speech transduction devices 1040 can be any of a number of devices (e.g., hearing aid, speaker phone, telephone handset, cellular telephone handset, microphone, voice amplification system, videoconferencing system, audio-instrumented meeting room, audio recording system, voice recognition system, toy or robot, voice-over-internet-protocol (VOIP) phone, teleconferencing phone, internet kiosk, personal digital assistant, gaming device, desktop computer, or laptop computer) used to enable the activities described below. Speech transduction device 1040 typically includes a microphone 1080 or similar audio inputs, a loudspeaker 1100 or similar audio outputs (e.g., headphones), and a network interface 1120. In some embodiments, speech transduction device 1040 is a client of speech transduction server 1020, as illustrated in FIG. 1. In other embodiments, speech transduction device 1040 is a stand-alone device that performs speech transduction without needing to use the communications network 1060 and/or the speech transduction server 1020 (e.g., device 1040-2, FIG. 3B). Throughout this document, the term “speaker” refers to the person speaking and the term “loudspeaker” is used to refer to the electrical component that emits sound.

Speech transduction server 1020 is a server computer that may be used to process acoustic data for speech transduction. Speech transduction server 1020 may be located with one or more speech transduction devices 1040, remote from one or more speech transduction devices 1040, or anywhere else (e.g., at the facility of a speech transduction services provider that provides services for speech transduction).

Communication network(s) 1060 may be wired or wireless communication networks, including wired communication networks, for example those communicating through phone lines, power lines, cable lines, or any combination thereof, wireless communication networks for example those communicating in accordance with one or more wireless communication protocols, such as IEEE 802.11 protocols, time-division-multiplex-access (TDMA), code-division-multiplex-access (CDMA), global system for mobile (GSM) protocols, WIMAX protocols, or any combination thereof, and any combination of such wired and wireless communication networks. Communication network(s) 1060 may be the Internet, other wide area networks, local area networks, metropolitan area networks, and the like.

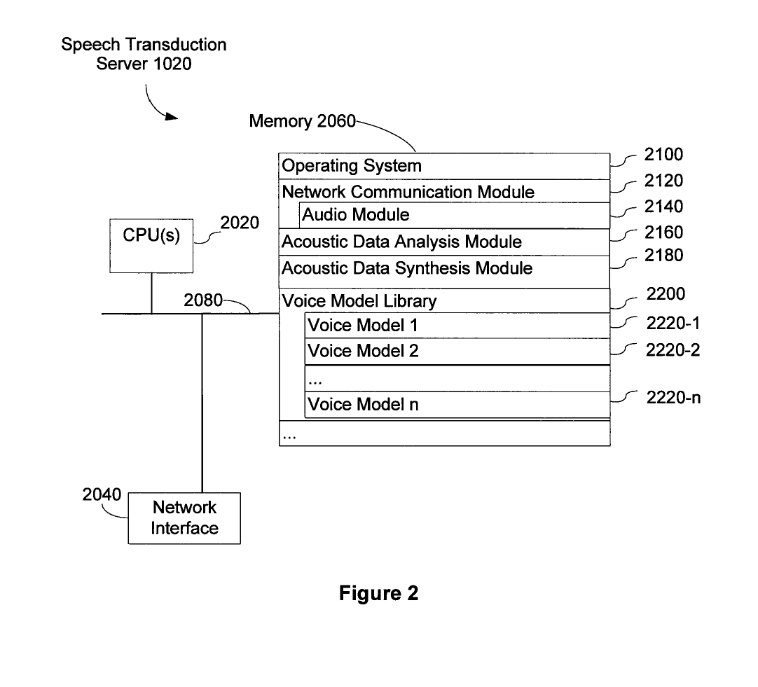

FIG. 2 is a block diagram illustrating a speech transduction server 1020 in accordance with some embodiments. Server 1020 typically includes one or more processing units (CPUs) 2020, one or more network or other communications interfaces 2040, memory 2060, and one or more communication buses 2080 for interconnecting these components. Server 1020 may optionally include a graphical user interface (not shown), which typically includes a display device, a keyboard, and a mouse or other pointing device. Memory 2060 may include high-speed random access memory and may also include non-volatile memory, such as one or more magnetic or optical storage disks. Memory 2060 may optionally include mass storage that is remotely located from CPUs 2020. Memory 2060 may store the following programs, modules and data structures, or a subset or superset thereof, in a computer readable storage medium:
Operating System 2100 that includes procedures for handling various basic system services and for performing hardware dependent tasks;
Network Communication Module (or instructions) 2120 that is used for connecting server 1020 to other computers (e.g., speech transduction devices 1040) via the one or more communications Network Interfaces 2040 (wired or wireless) and one or more communications networks 1060 (FIG. 1), such as the Internet, other wide area networks, local area networks, metropolitan area networks, and so on;
Acoustic Data Analysis Module 2160 that analyzes acoustic data received by Network Communication Module 2120;
Acoustic Data Synthesis Module 2180 that modifies the acoustic data analyzed by Acoustic Data Analysis Module 2160 and converts the modified acoustic data to an output waveform; and
Voice Model Library 2200 that contains one or more Voice Models 2220.

Network Communication Module 2120 may include Audio Module 2140 that coordinates audio communications (e.g., conversations) between speech transduction devices 1040 or between speech transduction device 1040 and speech transduction server 1020. In some embodiments, the audio communications between speech transduction devices 1040 are performed in a manner that does not require the use of server 1020, such as via peer-to-peer networking.

Acoustic Data Analysis Module 2160 is adapted to analyze acoustic data. The Acoustic Data Analysis Module 2160 is further adapted to determine characteristics of the acoustic data that are incompatible with human speech characteristics of acoustic data.

Acoustic Data Synthesis Module 2180 is adapted to modify the acoustic data to reduce the characteristics of the acoustic data that are incompatible with human speech characteristics of acoustic data. In some embodiments, Acoustic Data Synthesis Module 2180 is further adapted to convert the modified far-field acoustic data to produce an output waveform.

Voice Model Library 2200 contains two or more Voice Models 2220. Voice Model 2220 includes human speech characteristics for segments of sounds, and characteristics that span multiple segments (e.g., the rate of change of formant frequencies). A segment is a short frame of acoustic data, for example of 15-20 milliseconds duration. In some embodiments, multiple frames may partially overlap one another, for example by 25%. A list of human speech characteristics that may be included in a voice model is listed in Table 1.

TABLE 1
Examples of human speech characteristics

| Category | Speech Properties |
|---|---|
| Overall speech | Overall pitch of the waveform contained in a segment |
| properties | Unvoiced consonant attack time & release time |
| Formant | Formant filter coefficients |
| coefficients & | Estimated vocal tract length |
| properties | |
| Excitation | Excitation waveform |
| properties | Harmonic magnitudes H1 and H2 |
| | Overall pitch of the waveform contained in this block |
| | Glottal Closure Instants (Rd value, Open Quotient) |
| | Noise/Harmonic power ratio |
| | tₐ and tₑ |
| Formant | Peak frequencies and bandwidths of formants 1, 2, |
| Information | and 3 for each set of filter coefficients mentioned above |
| and | Principal Component magnitudes and vectors |
| Properties | Singular Value Decomposition magnitudes and vectors |
| | Machine-learning based clustering and classifications |

In some embodiments, the human speech characteristics include at least one pitch. Pitch can be determined by well known methods, for example autocorrelation. In some embodiments, the maximum, minimum, mean, or standard deviation of the pitch across multiple segments are calculated.

In some embodiments, the human speech characteristics include unvoiced consonant attack time and release time. The unvoiced consonant attack time and release time can be determined, for example by scanning over the near-field acoustic data. The unvoiced consonant attack time is the time difference between onset of high frequency sound and onset of voiced speech. The unvoiced consonant release time is the time difference between stopping of voiced speech and stopping of speech overall (in a quiet environment). The unvoiced consonant attack time and release time may be used in a noise reduction process, to distinguish between noise and unvoiced speech.

In some embodiments, the human speech characteristics include formant filter coefficients and excitation (also called “excitation waveform”). In analysis and synthesis of speech, it is helpful to characterize acoustic data containing speech by its resonances, known as ‘formants’. Each ‘formant’ corresponds to a resonant peak in the magnitude of the resonant filter transfer function. Formants are characterized primarily by their frequency (of the peak in the resonant filter transfer function) and bandwidth (width of the peak). Formants are commonly referred to by number, in order of increasing frequency, using terms such as F1 for the frequency of formant #1. The collection of formants forms a resonant filter that when excited by white noise (in the case of unvoiced speech) or by a more complex excitation waveform (in the case of voiced speech) will produce an approximation to the speech waveform. Thus a speech waveform may be represented by the ‘excitation waveform’ and the resonant filter formed by the ‘formants’.

In some embodiments, the human speech characteristics include magnitudes of harmonics of the excitation waveform. The magnitude of the first harmonic of the excitation waveform is H1, and the magnitude of the second harmonic of the excitation waveform is H2. H1 and H2 can be determined, for example, by calculating the pitches of the excitation waveform, and measuring the magnitude of a power spectrum of the excitation waveform at the pitch frequencies.

In some embodiments, the human speech characteristics include tₐ and tₑ, which are parameters in an LF-model (also called a glottal flow model with four independent parameters), as described in Fant et al., “A Four-Parameter Model of Glottal Flow,” STL-QPSR, 26(4): 1-13 (1985).

In some embodiments, Memory 2060 stores one Voice Model 2220 instead of a Voice Model Library 2200. In some embodiments, Voice Model Library 2200 is stored at another server remote from Speech Transduction Server 1020, and Memory 2060 includes a Voice Module Receiving Module that receives a Voice Model 2220 from the server remote from Speech Transduction Server 1020.

Each of the above identified modules and applications corresponds to a set of instructions for performing one or more functions described above. These modules (i.e., sets of instructions) need not be implemented as separate software programs, procedures or modules, and thus various subsets of these modules may be combined or otherwise re-arranged in various embodiments. In some embodiments, memory 2060 may store a subset of the modules and data structures identified above. Furthermore, memory 2060 may store additional modules and data structures not described above.

Although FIG. 2 shows server 1020 as a number of discrete items, FIG. 2 is intended more as a functional description of the various features which may be present in server 1020 rather than as a structural schematic of the embodiments described herein. In practice, and as recognized by those of ordinary skill in the art, items shown separately could be combined and some items could be separated. For example, some items shown separately in FIG. 2 could be implemented on single servers and single items could be implemented by one or more servers. The actual number of servers in server 1020 and how features are allocated among them will vary from one implementation to another, and may depend in part on the amount of data traffic that the system must handle during peak usage periods as well as during average usage periods.

FIGS. 3A and 3B are block diagrams illustrating two exemplary speech transduction devices 1040 in accordance with some embodiments. As noted above, speech transduction device 1040 typically includes a microphone 1080 or similar audio inputs, and a loudspeaker 1100 or similar audio outputs. Speech transduction device 1040 typically includes one or more processing units (CPUs) 3020, one or more network or other communications interfaces 1120, memory 3060, and one or more communication buses 3080 for interconnecting these components. Memory 3060 may include high-speed random access memory and may also include non-volatile memory, such as one or more magnetic or optical storage disks. Memory 3060 may store the following programs, modules and data structures, or a subset or superset thereof, in a computer readable storage medium:
Operating System 3100 that includes procedures for handling various basic system services and for performing hardware dependent tasks;
Network Communication Module (or instructions) 3120 that is used for connecting speech transduction device 1040 to other computers (e.g., server 1020 and other speech transduction devices 1040) via the one or more communications Network Interfaces 3040 (wired or wireless) and one or more communication networks 1060 (FIG. 1), such as the Internet, other wide area networks, local area networks, metropolitan area networks, and so on;
Acoustic Data Analysis Module 2160 that analyzes acoustic data received by Network Communication Module 3120;
Acoustic Data Synthesis Module 2180 that converts the acoustic data analyzed by Acoustic Data Analysis Module 2160 to an output waveform; and
Voice Model Library 2200 that contains one or more Voice Models 2220.

Network Communication Module 3120 may include Audio Module 3140 that coordinates audio communications (e.g., conversations) between speech transduction devices 1040 or between speech transduction device 1040 and speech transduction server 1020.

In some embodiments, Memory 3060 stores one Voice Model 2220 instead of a Voice Model Library 2200. In some embodiments, Voice Model Library 2200 is stored at another server remote from speech transduction device 1040, and Memory 3060 stores Voice Module Receiving Module that receives a Voice Model 2220 from the server remote from speech transduction device 1040.

As illustrated schematically in FIG. 3B, speech transduction device 1040-2 can incorporate modules, applications, and instructions for performing a variety of analysis and/or synthesis related processing tasks, at least some of which could be handled by Acoustic Data Analysis Module 2160 or Acoustic Data Synthesis Module 2180 in server 1020 instead. A speech transduction device such as device 1040-2 may thus act as stand-alone speech transduction device that does not need to communicate with other computers (e.g., server 1020) in order to perform speech transduction (e.g., on acoustic data received via microphone 1080, FIG. 3B).

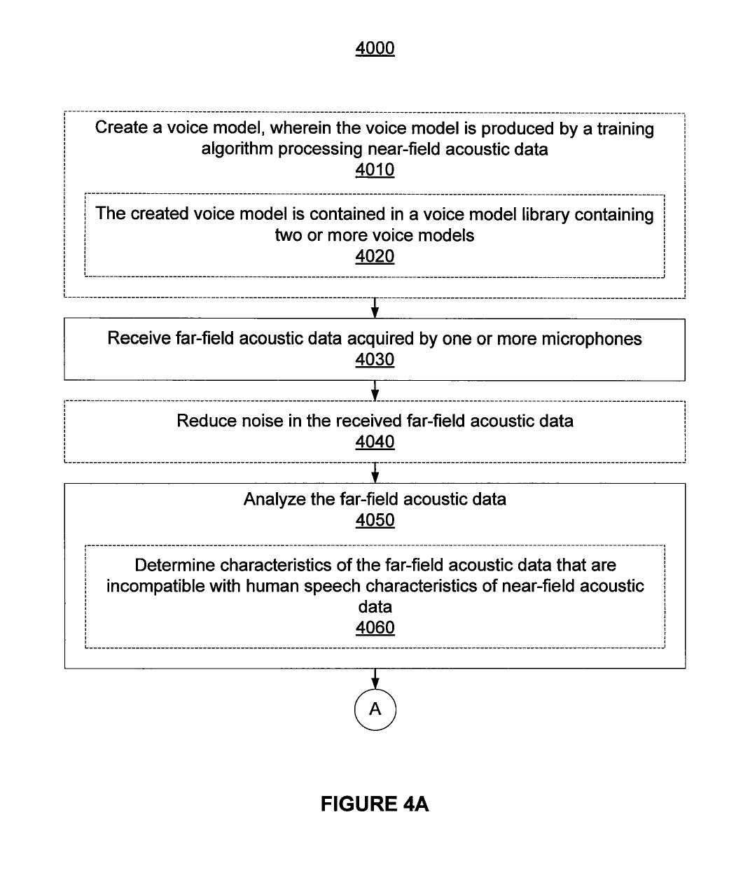

FIGS. 4A, 4B, and 4C are flowcharts of a speech transduction method in accordance with some embodiments. FIGS. 4A, 4B, and 4C show processes performed by server 1020 or by a speech transduction device 1040 (e.g., 1040-2, FIG. 3B). It will be appreciated by those of ordinary skill in the art that one or more of the acts described may be performed by hardware, software, or a combination thereof, as may be embodied in one or more computing systems. In some embodiments, portions of the processes performed by server 102 can be performed by speech transduction device 1040 using components analogous to those shown for server 1020 in FIG. 2.

In some embodiments, prior to receiving far-field acoustic data acquired by one or more microphones, a voice model 2220 is created (4010). In some embodiments, the voice model 2220 is produced by a training algorithm that processes near-field acoustic data. In some embodiments, to produce a voice model, near-field acoustic data containing human speech is acquired. In some embodiments, the acquired near-field acoustic data is segmented into multiple segments, each segment consisting, for example, of 15-20 milliseconds of near-field acoustic data. In some embodiments, multiple segments may partially overlap one another, for example by 25%. Human speech characteristics are calculated for the segments Some characteristics, such as formant frequency, are typically computed for each segment. Other characteristics that require examination of time-based trends, such as the rate of change of formant frequency, are typically computed across multiple segments. In some embodiments, the voice model 2220 includes maximum and minimum values of the human speech characteristics. In some embodiments, the created voice model 2220 is contained (4020) in a voice model library containing two or more voice models.

A device (e.g., server 1020 or speech transduction device 1040-2) receives (4030) far-field acoustic data acquired by one or more microphones. For example, server 1020 may receive far-field acoustic data acquired by one or more microphones 1080 in a client speech transduction device (e.g., device 1040-1, FIG. 3A). For example, a stand-alone speech transduction device may receive far-field acoustic data acquired by one or more its microphones 1080 (e.g., microphones 1080 in device 1040-2, FIG. 3B).

As used in the specification and claims, the one or more microphones 1080 acquire “far-field” acoustic data when the speaker generates speech at least a foot away from the nearest microphone among the one or more microphones. As used in the specification and claims, the one or more microphones acquire “near-field” acoustic data when the speaker generates speech less than a foot away from the nearest microphone among the one or more microphones.

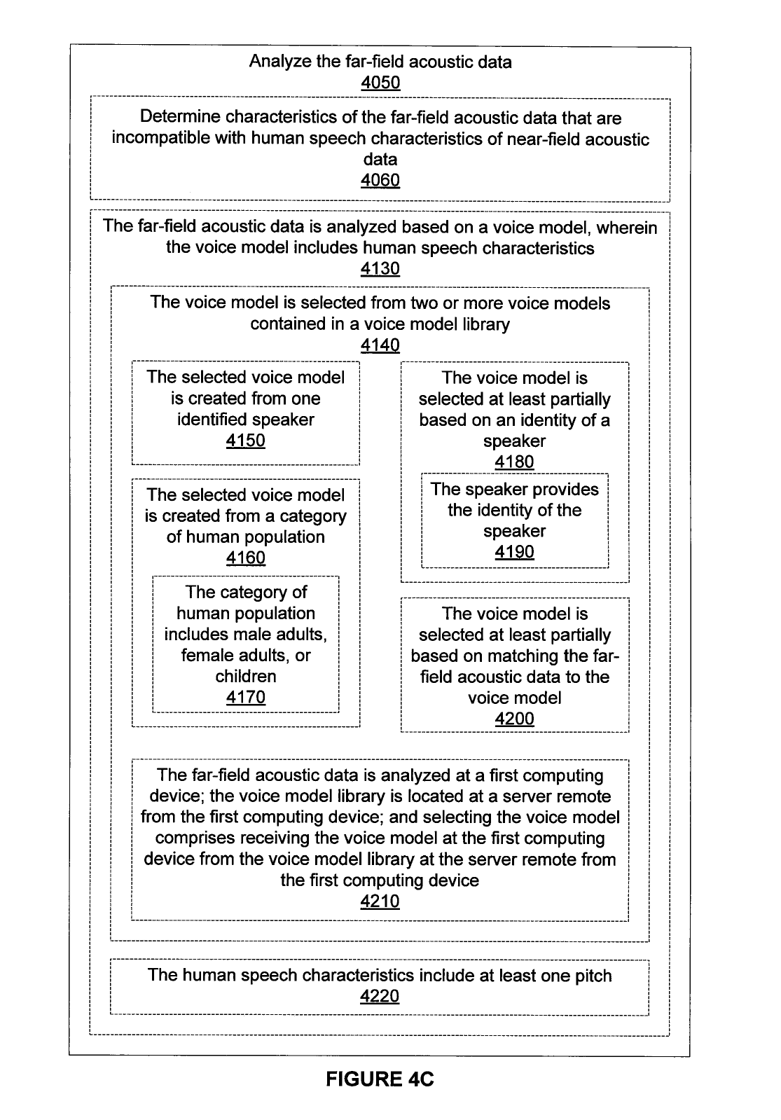

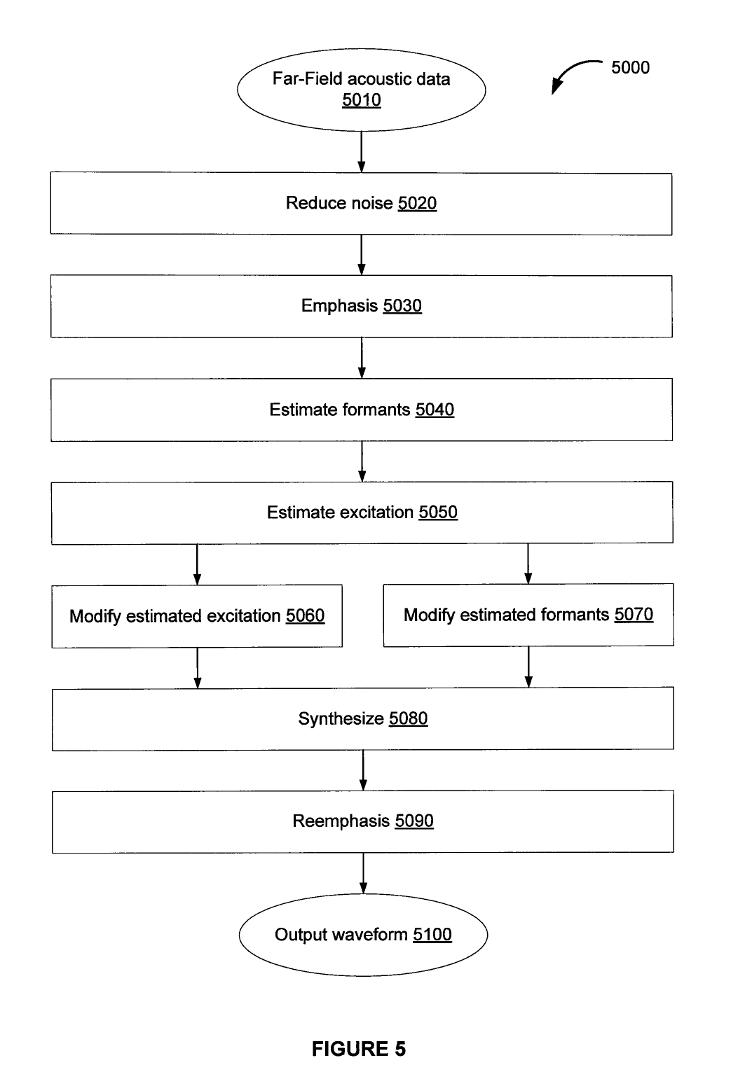

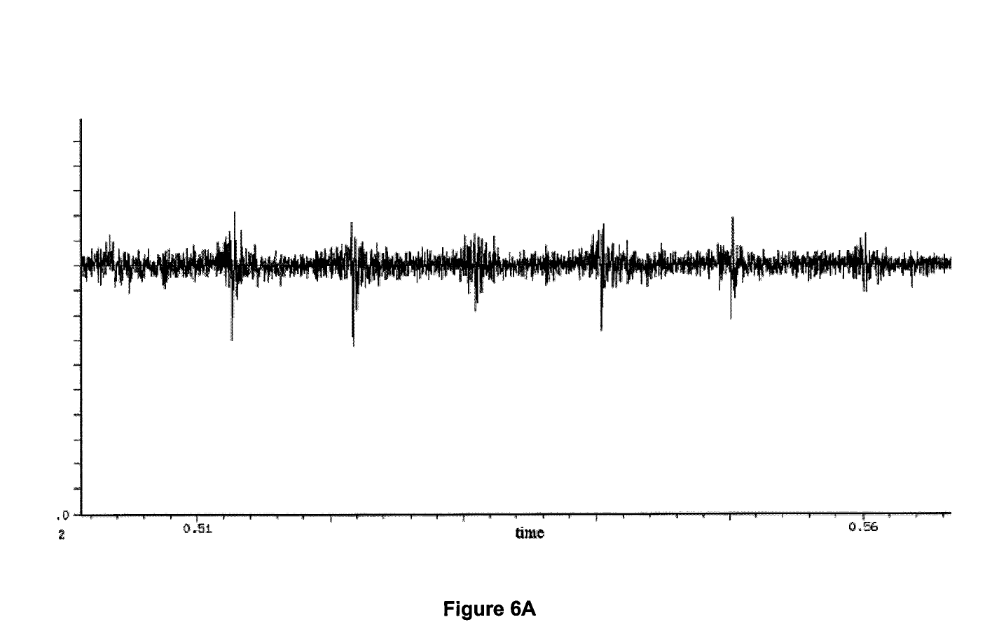

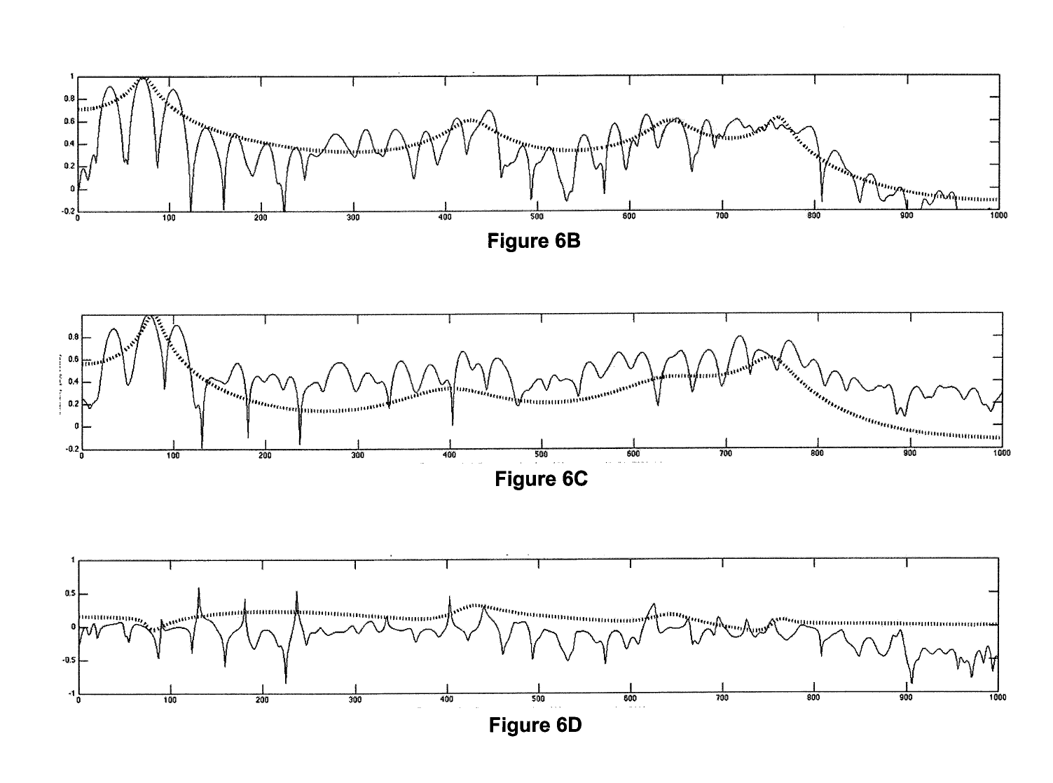

The far-field acoustic data may be received in the form of electrical signals or logical signals. In some embodiments, the far-field acoustic data may be electrical signals generated by one or more microphones in response to an input sound, representing the sound over a period of time, as illustrated in FIG. 6A. The input sound at times includes speech generated by a speaker.

In some embodiments, the acquired far-field acoustic data is processed to reduce noise in the acquired far-field acoustic data (4040). There are many well known methods to reduce noise in acoustic data. For example, the noise may be reduced by performing a multi-band spectral subtraction, as described in “Speech Enhancement: Theory and Practice” by Philipos C. Loizou, CRC Press (Boca Raton, Fla.), Jun. 7, 2007.

The far-field acoustic data (either as-received or after noise reduction) is analyzed (4050). The analysis of the far-field acoustic data includes determining (4060) characteristics of the far-field acoustic data that are incompatible with human speech characteristics of near-field acoustic data.

In some embodiments, a table containing human speech characteristics may be used to determine characteristics of the far-field acoustic data that are incompatible with human speech characteristics of near-field acoustic data. The table typically contains maximum and minimum values of human speech characteristics of near-field acoustic data. In some embodiments, the table receives the maximum and minimum values of human speech characteristics of near-field acoustic data, or other values of human speech characteristics of near-field acoustic data from a voice model 2220, as described below.

In some embodiments, the received far-field acoustic data is segmented into multiple segments, and characteristic values are calculated for each segment. For each segment, characteristic values are compared to the maximum and minimum values for corresponding characteristics in the table, and if at least one characteristic value of the far-field acoustic data does not fall within a range between the minimum and maximum values for that characteristic, the characteristic value of the far-field acoustic data is determined to be incompatible with human speech characteristics of near-field acoustic data. In some embodiments, a predefined number of characteristics that fall outside the range between the minimum and maximum values may be accepted as not incompatible with human speech characteristics of near-field acoustic data. In some other embodiments, the range used to determine whether the far-field acoustic data is incompatible with human speech characteristics of near-field acoustic data may be broader than between the minimum and maximum values. For example, the range may be between 90% of the minimum value and the 110% of the maximum value. In some embodiments, the range may be determined based on the mean and standard deviation or variance of the characteristic value, instead of the minimum and maximum values.

In a related example, the table may contain frequencies generated in human speech. The maximum frequency may be, for example 500 Hz, and the minimum frequency may be, for example 20 Hz. If any segment of the far-field acoustic data contains any sound of frequency 500 Hz or above, such sound is determined to be incompatible with human speech characteristics.

In some embodiments, multivariate methods can be used to determine (4060) characteristics of the far-field acoustic data that are incompatible with human speech characteristics of near-field acoustic data. For example, least squares fits of the characteristic values or their power, Euclidean distance or logarithmic distance among the characteristic values, and so forth can be used to determine characteristics incompatible with human speech characteristics of near-field acoustic data.

The received far-field acoustic data is modified (4070) to reduce the characteristics of the far-field acoustic data that are incompatible with human speech characteristics of near-field acoustic data.

In some embodiments, if the far-field acoustic data contains sound that is not within the frequency range of human speech (e.g., a high frequency metal grinding sound), a band-pass filter or low-pass filter well-known in the field of signal processing may be used to reduce the high frequency metal grinding sound.

In some embodiments, when the pitch of speech in the far-field acoustic data is too high, the far-field acoustic data are stretched in time to lower the pitch. Conversely, when the pitch of speech in the far-field acoustic data is too low, the far-field acoustic data may be compressed in time to raise the pitch.

In some embodiments, the far-field acoustic data is modified (4080) in accordance with one or more speaker preferences. For example, a speaker may be speaking in a noisy environment and may want to perform additional noise reduction. In some embodiments, a speaker may provide a type of environment (e.g., via preference control settings on the device 1040) and the additional noise reduction may be tailored for the type of environment. For example, a speaker may be driving, and the speaker may activate a preference control on the device 1040 to reduce noise associated with driving. The noise reduction may use a band-pass filter to reduce low frequency noise, such as those from the engine and the road, and high frequency noise, such as wind noise.

In some embodiments, the far-field acoustic data is modified (4090) in accordance with one or more listener preferences. Such listener preferences may include emphasis/avoidance of certain frequency ranges, and introduction of spatial effects. For example, a listener may have a surround speaker system 1100, and may want to make the sound emitted from the one or more speakers sound like the speaker is speaking from a specific direction. In another example, a listener may want to make a call sound like a whisper so as not to disturb other people in the environment.

In some embodiments, the modified far-field acoustic data is converted (4100) to produce an output waveform. In some embodiments, the modified far-field acoustic data include mathematical equations, an index to an entry in a database (such as a voice model library), or values of human speech characteristics. Therefore, converting (4100) the modified far-field acoustic data includes processing such data to synthesize an output waveform that a listener would recognize as human speech.

For example, when the modified far-field acoustic data includes a vocal tract excitation and a formant, converting the modified far-field acoustic data to produce an output waveform requires mathematically calculating the convolution of the vocal tract excitation and the excitation. In some other embodiments, the modified far-field acoustic data exists in the form of a waveform, similar to the example shown in FIG. 6A. In such cases, converting the modified far-field acoustic data to an output waveform requires simply treating the modified far-field acoustic data as an output waveform.

In some embodiments, the output waveform is modified (4110) in accordance with one or more speaker preferences. In some embodiments, this modification is performed in a manner similar to modifying (4080) the far-field acoustic data in accordance with one or more speaker preferences. In some embodiments, the output waveform is modified (4120) in accordance with one or more listener preferences. In some embodiments, this modification is performed in a manner similar to modifying (4090) the modified far-field acoustic data in accordance with one or more speaker preferences.

In some embodiments, when the synthesis is performed at a speech transduction server 1020, the output waveform may be sent to a speech transduction device 1040 for output via a loudspeaker 1100. In some embodiments, when the synthesis is performed at a speech transduction device 1040, the output waveform may be an output from a loudspeaker 11100.

In some embodiments, the modified far-field acoustic data is sent to a remote device (4130). For example, the modified far-field acoustic data may be sent from a speech transduction server 1020 to a speech transduction device 1040, where the modified far-field acoustic data may be converted to an output waveform (e.g., by loudspeaker 1100 on device 1040).

FIG. 4C is a flowchart for analyzing (4050) far-field acoustic data in accordance with some embodiments.

In some embodiments, the far-field acoustic data is analyzed (4130) based on a voice model that includes human speech characteristics. In some embodiments, the human speech characteristics include (4220) at least one pitch. A respective pitch represents a frequency of sound generated by a speaker while the speaker pronounces a segment of a predefined word. As described above, the voice model may include maximum and minimum values of human speech characteristics, which may be used to determine characteristics of far-field acoustic data that are incompatible with human speech characteristics of near-field acoustic data.

In some embodiments, the voice model is selected (4140) from two or more voice models contained in a voice model library. In some embodiments, the selected voice model is created (4150) from one identified speaker. For example, Speaker A may create a voice model based on Speaker A's speech, and name the voice model as “Speaker A's voice model.” Speaker A knows that the “Speaker A's voice model” was created from Speaker A, an identified speaker, because Speaker A created the voice model and because the voice model is named as such.

In some embodiments, when Speaker A is speaking, it is preferred that Speaker A's voice model is used. Therefore, in some embodiments, the voice model is selected (4180) at least partially based on an identity of a speaker. For example, if Speaker A's identity can be determined, Speaker A's voice model will be used. In some embodiments, the speaker provides (4190) the identity of the speaker. For example, like a computer log-in screen, a phone may have multiple user login icons, and Speaker A would select an icon associated with Speaker A. In some other embodiments, several factors, such as the time of phone use, location, Internet protocol (IP) address, and a list of potential speakers, may be used to determine the identity of the speaker.

In some embodiments, the voice model is selected (4200) at least partially based on matching the far-field acoustic data to the voice model. For example, if the pitch of a child's voice never goes below 200 Hz, a voice model is selected in which the pitch does not go below 200 Hz. In some embodiments, similar to the method of identifying characteristics of the far-field acoustic data that are incompatible with human speech characteristics of the near-field acoustic data, characteristics of the far-field acoustic data are calculated, and a voice model whose characteristics match the characteristics of the far-field acoustic data is selected. Exemplary methods of matching the characteristics of the far-field acoustic data and the characteristics of voice models include the table-based comparison as described with reference to determining the incompatible characteristics and multivariate methods described above.

In some embodiments, the selected voice model is created (4160) from a category of human population. In some embodiments, the category of human population includes (4170) male adults, female adults, or children. In some embodiments, the category of human population includes people from a particular geography, such as North America, South America, Europe, Asia, Africa, Australia, or the Middle-East. In some embodiments, the category of human population includes people from a particular region in the United States with a distinctive accent. In some embodiments, the category of human population may be based on race, ethnic background, age, and/or gender.

In some embodiments, the far-field acoustic data is analyzed at a speech transduction device 1040 (e.g., hearing aid, speaker phone, telephone handset, cellular telephone handset, microphone, voice amplification system, videoconferencing system, audio-instrumented meeting room, audio recording system, voice recognition system, toy or robot, voice-over-internet-protocol (VOIP) phone, teleconferencing phone, internet kiosk, personal digital assistant, gaming device, desktop computer, or laptop computer), and the voice model library 2200 is located at a server 1020 remote from the speech transduction device. In some embodiments, the speech transduction device 1040 receives the voice model 2220 from the voice model library 2200 at the server 1020 remote from the speech transduction device 1040 when the speech transduction device 1040 selects the voice model.

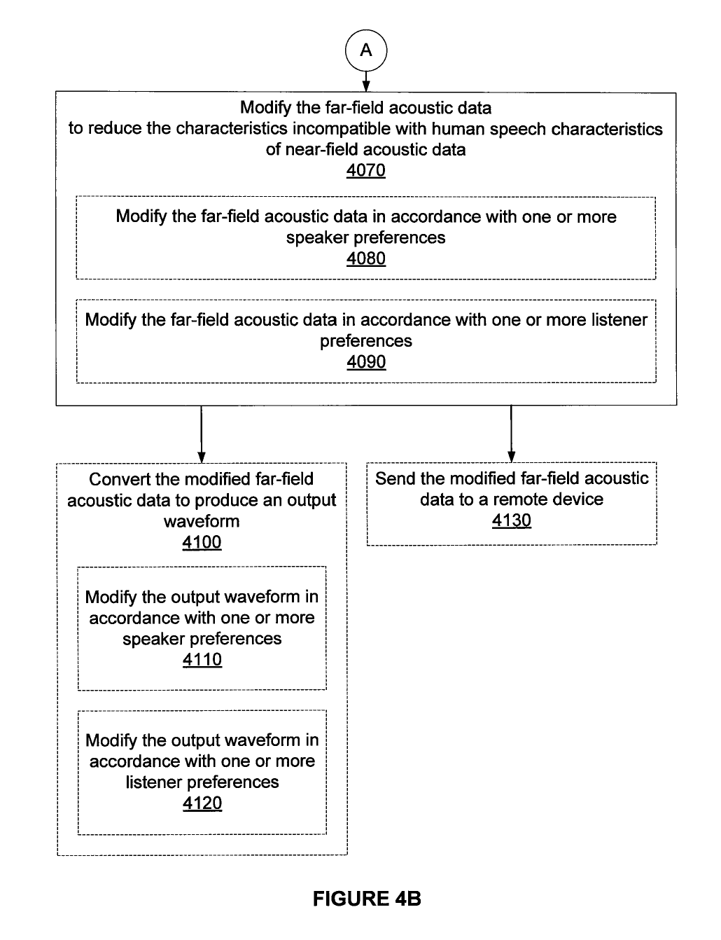

FIG. 5 is a flowchart of a speech transduction method in accordance with some embodiments. Far-field acoustic data acquired by one or more microphones is received (5010). Noise is reduced (5020) in the received far-field acoustic data (e.g., as described above with respect to noise reduction 4040, FIG. 4A). The noise-reduced far-field acoustic data is “emphasized” (5030). The emphasis is performed to reduce interfering sound effects, for example echoes. Emphasis methods are known in the field. For example, see Sumitaka et al., “Gain Emphasis Method for Echo Reduction Based on a Short-Time Spectral Amplitude Estimation,” Transactions of the Institute of Electronics, Information and Communication Engineers. A, J88-A(6): 695-703 (2005).

Formants of the emphasized far-field acoustic data are estimated (5040), and excitations of the emphasized far-field acoustic data are estimated (5050). Methods for estimating formants and excitations are known in the field. For example, the formants and excitations can be estimated by a linear predictive coding (LPC) method. See Makhoul, “Linear Prediction, A Tutorial Review”, Proceedings of the IEEE, 63(4): 561-580 (1975). Also, a computer program to perform the LPC method is commercially available. See lpc function in Matlab Signal Processing Toolbox (MathWorks, Natick, Mass.). FIG. 6B illustrates a spectrum of near-field acoustic data (solid line) along with the formants (dotted line) estimated in Matlab. Similarly, FIG. 6C illustrates a spectrum of far-field acoustic data (solid line) along with the formants (dotted line) estimated in Matlab. FIG. 6D illustrates the difference between the spectrum of near-field acoustic data (FIG. 6B) and the spectrum of far-field acoustic data (FIG. 6C).

The estimated excitation is modified (5060). In some embodiments, the estimated excitation is compared to excitations stored in a voice model. If a matching excitation is found in the voice model, the matching excitation from the voice model is used in place of the estimated excitation. In some embodiments, matching the estimated excitation to the excitation stored in a voice model depends on the estimated formants. For example, a record is selected within the voice model that contains formants to which the estimated formants are a close match. Then the estimated excitation is updated to more closely match the excitation stored in that voice model record. In some embodiments, the matched excitation stored in the selected voice model record is stretched or compressed so that the pitch of the excitation from the library matches the pitch of the far-field acoustic data.

The estimated formants are modified (5070). In some embodiments, the estimated formants are modified in accordance with a Steiglitz-McBride method. For example, see Steiglitz and McBride, “A Technique for the Identification of Linear Systems,” IEEE Transactions on Automatic Control, pp. 461-464 (October 1965). In some embodiments, a parameterized model, such as the LF-model described in Fant et al., is used to fit to the low-pass filtered excitation. The LF-model fit is used for modifying the estimated formants. An initial error is calculated as follows:

(Initial error)=[(LF-model fit)×(initially estimated formant)×(initially estimated formant)]−[(emphasized far-field acoustic data)×(initially estimated formant)],

where × indicates convolution.
Having determined the initial error, the formant coefficients are adjusted in a linear solver to minimize the magnitude of the error. Once the formant coefficients are adjusted, the adjusted formant is used to recalculate the error (termed the “iterated error”) as follows:

(Iterated error)=[(LF-model fit)×(initially estimated formant)×(adjusted formant)]−[(emphasized far-field acoustic data)×(adjusted formant)],

where × indicates convolution.

The modified formants may be further processed, for example via pole reflection, or additional shaping.

The modified formants and estimated excitation are convoluted to synthesize a waveform (5080). The waveform is again emphasized (5090) to produce (5100) an output waveform.

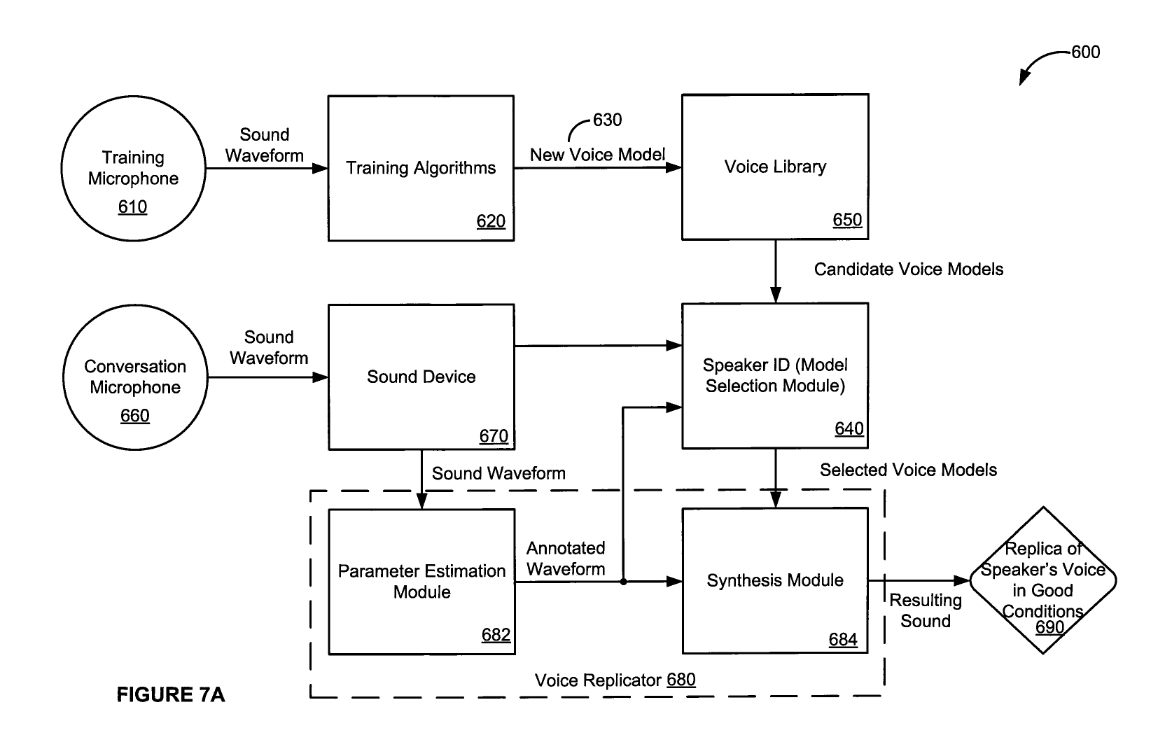

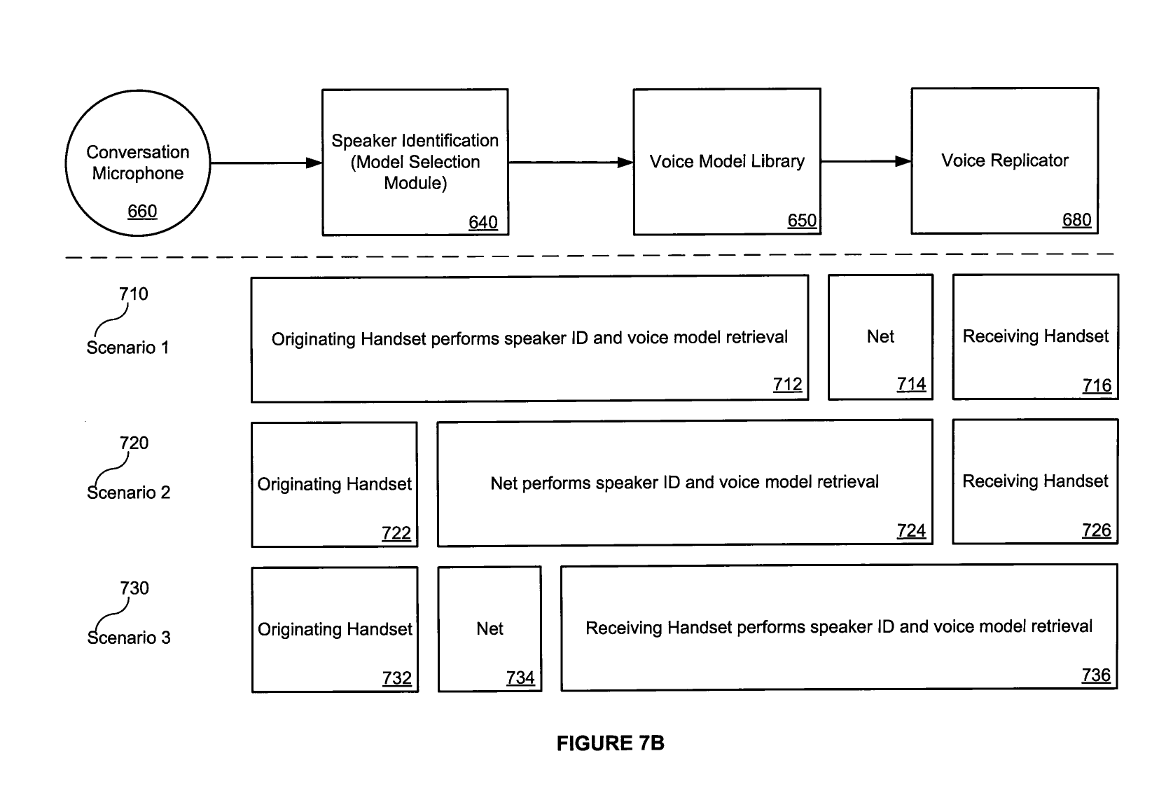

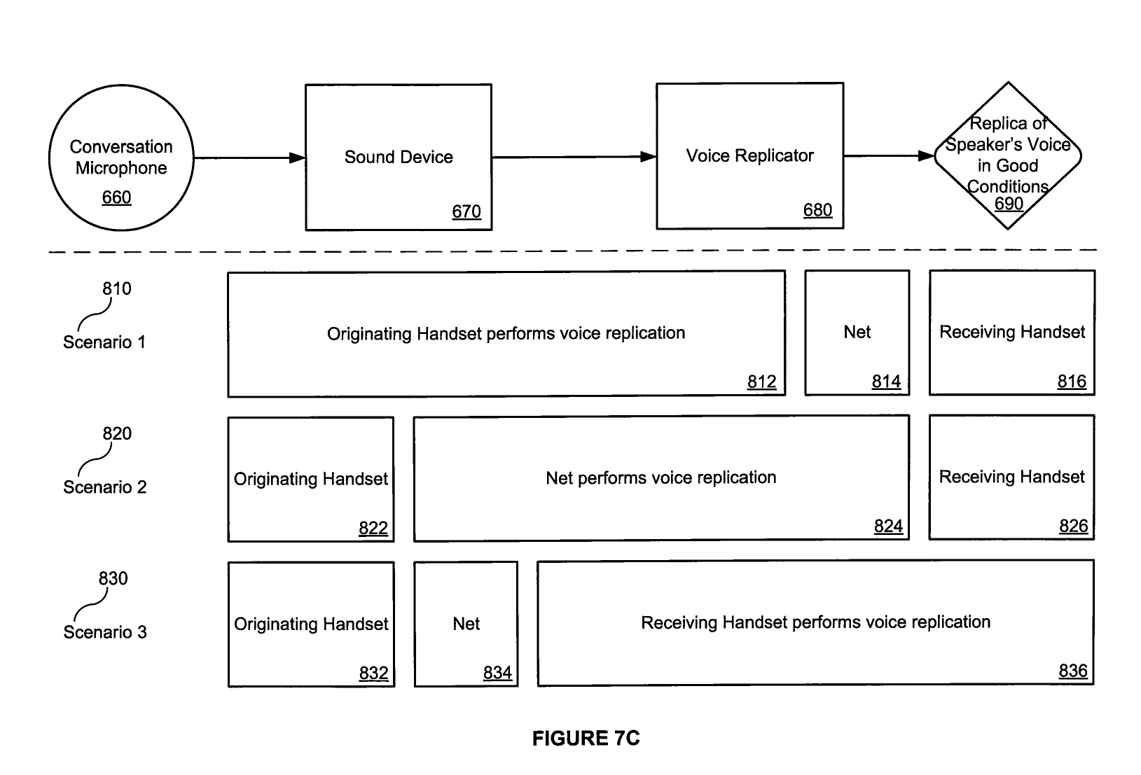

FIG. 7A illustrates an example of a speech transduction system in accordance with some embodiments. Speech transduction system 600 includes a training microphone 610 that captures high-quality sound waves. The training microphone 610 is a near-field microphone. The training microphone 610 transmits the high-quality sound waves (in other words, near-field acoustic data) to a training algorithms module 620. The training algorithms module 620 performs a training operation that creates a new voice model 630. The training operation will be discussed in more detail below.

The speech transduction system 600 further includes voice model library 650 configured to store the new voice model 630. In some embodiments, the voice model library 650 contains personalized models of the voice of each speaker as the speaker's voice would sound under ideal conditions. In some embodiments, the voice model library 650 generates personalized speech models through automatic analysis and categorization of a speaker's voice. In some embodiments, the speech transduction system 600 includes tools for modifying the models in the voice model library 650 to suit the preferences of the person speaking, e.g., to smooth a raspy voice, etc.

The voice model library 650 may be stored in various locations. In some embodiments, the voice model library 650 is stored within a telephone network. In some embodiments, it is stored at the listener's phone handset. In some embodiments, the voice model library 650 is stored within the speaker's phone handset. In some embodiments, the voice model library 650 is stored within a computer network that is operated independently of the telephone network, i.e., a third party service provider.

A conversation microphone 660 captures far-field sound waves (in other words, far-field acoustic data) of the current speaker and transmits the far-field acoustic data to a sound device 670. In some embodiments, the sound device 670 may be a hearing aid, a speaker phone or audio-instrumented meeting room, a videoconferencing system, a telephone handset, including a cell phone handset, a voice amplification system, an audio recording system, voice recognition system, or even a children's toy.

A model selection module 640 is coupled to the sound device 670 and the voice model library 650. The model selection module 640 accommodates multiple users of the sound device 670, such as a cellular telephone, by selecting which personalized voice model from the voice model library 650 to use with the current speaker. This model selection module 640 may be as simple as a user selection from a menu/sign-in, or may involve more sophisticated automatic speaker-recognition techniques.

A voice replicator 680 is also coupled to the sound device 670 and the voice model library 670. The voice replicator 680 is configured to produce a resulting sound that is a replica of the speaker's voice in good acoustic conditions 690. As shown in FIG. 6, the voice replicator 680 of the speech transduction system 600 includes a parameter selection module 682 and a synthesis module 684.

The parameter estimation module 682 analyzes the acoustic data. The parameters estimation module 682 matches the acoustic data acquired by one or more microphones to the stored model of the speaker's voice. The parameter estimation module 682 outputs an annotated waveform. In some embodiments, the annotated waveform is transmitted to the model selection module 640 for automatic identification of the speaker and selection of the personalized voice model of the speaker.

The synthesis module 684 constructs a rendition of the speaker's voice based on the voice model 630 and on the acquired far-field acoustic data. The resulting sound is a replica of the speaker's voice in good conditions 690 (e.g., the speaker's voice sounds as if the speaker was speaking into a near-field microphone).

In some embodiments, the speech transduction system 600 also includes a modifying function that tailors the synthesized speech to the preferences of the speaker and/or listener.

FIG. 7B illustrates three scenarios for speaker identification and voice model retrieval in accordance with some embodiments. Selection and retrieval of the appropriate personalized voice model may occur in various locations of the system. In some embodiments, a first scenario 710 is employed wherein the speaker's handset does the speaker identification and voice model retrieval 712. In this scenario 710, the speaker's handset 712 may then transmit either the voice model or the resulting sound to telephone network 714 which in turn transmits either the voice model or the resulting sound to a receiving handset 716. In some embodiments, a second scenario 720 is employed wherein the speaker's handset 722 transmits the speaker's current sound waveform to the telephone network that performs the speaker identification and voice model retrieval 724. In this scenario 720, the telephone network 714 may then transmit either the voice model or the resulting sound to the receiving handset 716. In some embodiments, a third scenario 730 transmits the speaker's current sound waveform from the speaker's handset 732 through the telephone network 731 to the receiving handset, where the receiving handset performs the speaker identification and voice model retrieval 736.

FIG. 7C illustrates three scenarios for voice replication in accordance with some embodiments of the present invention. The process of voice replication may occur in various locations of the system. In some embodiments, a first scenario 810 is employed wherein the speaker's handset does the voice replication 812. In this scenario 810, the speaker's handset 812 could then transmit the resulting sound to telephone network 814 which in turn transmits the resulting sound to a receiving handset 816. In some embodiments, a second scenario 820 is employed wherein the speaker's handset 822 transmits the speaker's current sound waveform to the telephone network that does the voice replication 824. In this scenario 820, the telephone network 814 then transmits the resulting sound to the receiving handset 816. In some embodiments, a third scenario 830 transmits the speaker's current sound waveform from the speaker's handset 832 through the telephone network 831 to the receiving handset, where the receiving handset performs the voice replication 836.

Each of the methods described herein may be governed by instructions that are stored in a computer readable storage medium and that are executed by one or more processors of one or more servers or clients. Each of the operations shown in FIGS. 4A, 4B, and 4C may correspond to instructions stored in a computer memory or computer readable storage medium.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method of speech transduction, comprising:
receiving far-field acoustic data acquired by one or more microphones;
analyzing the far-field acoustic data; and
modifying the far-field acoustic data to reduce characteristics of the far-field acoustic data that are incompatible with human speech characteristics of near-field acoustic data.

2. The computer-implemented method of claim 1, wherein the far-field acoustic data is analyzed based on a voice model, wherein the voice model includes human speech characteristics.

3. The computer-implemented method of claim 2, wherein the voice model is selected from two or more voice models contained in a voice model library.

4. The computer-implemented method of claim 3, wherein the selected voice model is created from one identified speaker.

5. The computer-implemented method of claim 3, wherein the voice model is selected at least partially based on an identity of a speaker.

6. The computer-implemented method of claim 5, wherein the speaker provides the identity of the speaker.

7. The computer-implemented method of claim 3, wherein the selected voice model is created from a category of human population.

8. The computer-implemented method of claim 7, wherein the category of human population includes male adults, female adults, or children.

9. The computer-implemented method of claim 3, wherein the voice model is selected at least partially based on matching the far-field acoustic data to the voice model.

10. The computer-implemented method of claim 3, wherein
the far-field acoustic data is analyzed at a first computing device;
the voice model library is located at a server remote from the first computing device; and
selecting the voice model comprises receiving the voice model at the first computing device from the voice model library at the server remote from the first computing device.

11. The computer-implemented method of claim 2, wherein the human speech characteristics include at least one pitch.

12. The computer-implemented method of claim 1, wherein the far-field acoustic data is modified in accordance with one or more speaker preferences.

13. The computer-implemented method of claim 1, wherein the far-field acoustic data is modified in accordance with one or more listener preferences.

14. The computer-implemented method of claim 1, further comprising converting the modified far-field acoustic data to produce an output waveform.

15. The computer-implemented method of claim 14, further comprising modifying the output waveform in accordance with one or more speaker preferences.

16. The computer-implemented method of claim 14, further comprising modifying the output waveform in accordance with one or more listener preferences.

17. The computer-implemented method of claim 1, further comprising sending the modified far-field acoustic data to a remote device.

18. The computer-implemented method of claim 1, further comprising creating a voice model, wherein the voice model is produced by a training algorithm processing near-field acoustic data.

19. The computer-implemented method of claim 18, wherein the created voice model is contained in a voice model library containing two or more voice models.

20. The computer-implemented method of claim 1, further comprising reducing noise in the received far-field acoustic data prior to analyzing the far-field acoustic data.

21. The computer-implemented method of claim 1, wherein the analyzing comprises determining characteristics of the far-field acoustic data that are incompatible with human speech characteristics of near-field acoustic data.

22. A computer system for speech transduction, comprising:
one or more processors;
memory; and
one or more programs, wherein the one or more programs are stored in the memory and configured to be executed by the one or more processors, the programs including instructions for:
receiving far-field acoustic data acquired by one or more microphones;
analyzing the far-field acoustic data; and
modifying the far-field acoustic data to reduce characteristics of the far-field acoustic data that are incompatible with human speech characteristics of near-field acoustic data.

23. A computer readable storage medium having stored therein instructions, which when executed by a computing device, cause the device to:
receive far-field acoustic data acquired by one or more microphones;
analyze the far-field acoustic data; and
modify the far-field acoustic data to reduce characteristics of the far-field acoustic data that are incompatible with human speech characteristics of near-field acoustic data.
